(19) United States
(12) Patent Application Publication
(10) Pub. No.: US 2025/0180596 A1
(43) Pub. Date: Jun. 5, 2025

(54) WIND SPEED AND DIRECTION MEASUREMENT SYSTEM AND DEVICE

(71) Applicant: Ohio State Innovation Foundation, Columbus, OH (US)

(72) Inventors: Marcelo DAPINO, Columbus, OH (US); Leon HEADINGS, Hiliard, OH (US)

(21) Appl. No.: 18/843,934

(22) PCT Filed: Jul. 12, 2022
(86) PCT No.: PCT/US2022/036848

§ 371 Date: Sep. 4, 2024

Related U.S. Application Data
(60) Provisional application No. 63/316,777, filed on Mar. 4, 2022.

(51) Int. Cl. G01P 5/14; G01W 1/02; G01W 1/08

(52) U.S. Cl. CPC G01P 5/14; G01W 1/02; G01W 1/08

(57) ABSTRACT

Various implementations include a low-drag smart tether system for measuring fluid speed and direction. The system includes a sleeve, a pressure sensor, and a tether. The sleeve has a longitudinal axis and an airfoil shaped cross-section as viewed in a plane perpendicular to the longitudinal axis. The sleeve has a leading edge. The sleeve defines a tether opening extending parallel to the longitudinal axis. The pressure sensor is disposed along a surface of the sleeve. The pressure sensor is configured to measure the pressure exerted on the pressure sensor by air moving over the surface of the sleeve. The tether extends through the tether opening defined by the sleeve. The tether has a tether longitudinal axis. The tether opening is positioned such that fluid flowing around the sleeve causes the sleeve to rotate about the tether longitudinal axis.

### CROSS-REFERENCE TO RELATED APPLICATIONS

This application claims the benefit of U.S. Patent Application No. 63/316,777 filed Mar. 4, 2022, the content of which is incorporated herein by reference in its entirety.

### STATEMENT OF GOVERNMENT SUPPORT

This invention was made with government support under grant/contract number 1738723 awarded by the National Science Foundation. The government has certain rights in the invention.

### BACKGROUND

Airplanes and unmanned aerial systems typically use pitot tubes to measure airspeed. Pitot tubes are vulnerable to icing, necessitating anti-icing electrical heaters to prevent blockages. The electrical heaters reduce the energy efficiency of small and micro-aerial vehicles. There is also an increasing demand for accurate, low-cost wind monitors that are both scalable and efficient.

Cup and vane anemometers are the most common instrument for measuring wind speed and direction. They are installed primarily in weather observatories and wind farms and are considered a reliable instrument for surveying wind conditions. In spite of their structural robustness, they are typically large, heavy, and induce a large amount of drag, thus making them unsuitable for aerial applications. In addition, they suffer from high rotational inertia and friction between the components, making them unsuitable for measuring rapid changes such as wind gusts.

Heated-element or thermal anemometers measure wind speed and direction through measurement of the heat loss and/or temperature distribution induced by airflow. There are two types of thermal anemometers—calorimetric and hot wire. In the calorimetric type, the wind speed and direction are determined by the temperature gradient measured by the various sensing elements within the device. On the other hand, the hot-wire type is a thermistor that measures the change in resistance due to the heat lost in an airflow. A bridge circuit measures the variation in resistance that is calibrated against the wind speed. The primary advantages of this technology are its high accuracy and small footprint. However, in both techniques, the active element needs to be continuously heated which results in high power consumption for remote sensing relying on batteries or harvested energy. They also suffer from temperature drift and rapid thermal fluctuations at turbulent wind speeds.

There are also methods that utilize ultrasonic transducers to measure wind speed based on transit-time calculations. Ultrasonic anemometers use high-frequency vibrating membranes functioning as both transmitter and receiver of acoustic waves. Wind speed is obtained using the time-difference between the transmitted and received pulses. In order to measure wind direction in addition to wind speed, more than two transceivers are utilized and their relative difference in the time-of-flight or the phase difference between the transmitted and received signals is utilized to compute the wind direction. The configuration in which ultrasonic transducers are arranged within the anemometer leads to a non-aerodynamic design resulting in high aerodynamic drag.

Drag anemometers involve deflection of an active material when subjected to an airflow. The deflection is then measured using piezoelectric, piezoresistive, or optical-based strain gages. In spite of their small size, lower power consumption, and lower cost, it is challenging to arrange these sensors around a tether to obtain reliable wind direction measurements. Also, applicability of these sensors to a larger range of wind speed measurements needs further investigation.

### SUMMARY

Various implementations include a low-drag smart tether system for measuring fluid speed and direction. The system includes a sleeve, a pressure sensor, and a tether. The sleeve has a longitudinal axis and an airfoil shaped cross-section as viewed in a plane perpendicular to the longitudinal axis. The sleeve has a leading edge. The sleeve defines a tether opening extending parallel to the longitudinal axis. The pressure sensor is disposed along a surface of the sleeve. The pressure sensor is configured to measure the pressure exerted on the pressure sensor by air moving over the surface of the sleeve. The tether extends through the tether opening defined by the sleeve. The tether has a tether longitudinal axis. The tether opening is positioned such that fluid flowing around the sleeve causes the sleeve to rotate about the tether longitudinal axis.

In some implementations, the pressure sensor includes a strain-based pressure sensor. In some implementations, the pressure sensor includes a capacitive pressure sensor. In some implementations, the pressure sensor includes a piezo-electric sensor skin. In some implementations, the pressure sensor includes a diaphragm pressure sensor. In some implementations, the pressure sensor includes polyvinylidene difluoride (PVDF).

In some implementations, the pressure sensor includes a pressure sensitive skin, and the pressure sensitive skin is flush with the surface of the sleeve.

In some implementations, the pressure sensor is disposed closer to the leading edge of the sleeve than to a tailing edge of the sleeve.

In some implementations, the system further includes a directional sensor for measuring the cardinal orientation of the sleeve, and the directional sensor is coupled to the sleeve. In some implementations, the directional sensor includes a magnetometer compass. In some implementations, the directional sensor includes an angular encoder.

In some implementations, the tether includes Dyneema.

In some implementations, the sleeve includes polystyrene. In some implementations, the sleeve includes a honeycomb shaped material.

In some implementations, the sleeve is rotatable about the tether.

In some implementations, the system includes two or more sleeves and two or more pressure sensors, and each of the two or more pressure sensors is disposed along the surface of a different one of the two or more sleeves. In some implementations, each of the two or more sleeves rotates independently of the other sleeves.

In some implementations, the tether opening is positioned at a center of pressure of the sleeve. In some implementations, the sleeve has a chord length, and the tether opening is positioned between ⅛ and ⅜ of the chord length from the leading edge.

In some implementations, the system further includes a controller in communication with the pressure sensor and the magnetometer. In some implementations, the controller includes a wireless transmission device.

In some implementations, the airfoil shaped cross-section includes a NACA 2412 airfoil shaped cross-section.

In some implementations, the system includes an energy harvester.

### BRIEF DESCRIPTION OF DRAWINGS

Example features and implementations of the present disclosure are disclosed in the accompanying drawings. However, the present disclosure is not limited to the precise arrangements and instrumentalities shown. Similar elements in different implementations are designated using the same reference numerals.

FIG. 1 is a perspective view of a low-drag smart tether system for measuring fluid speed and direction, according to aspects of various implementations. The detail view in FIG. 1 is a schematic view of a single sleeve of the system.

FIG. 2 is a perspective view of a sleeve of the system of FIG. 1.

FIG. 3A is a side view of a pressure sensor of the system of FIG. 1.

FIG. 3B is a top view of the pressure system shown in FIG. 3A.

FIG. 3C is a perspective view of the pressure system shown in FIG. 3A.

### DETAILED DESCRIPTION

The devices, systems, and methods disclosed herein provide for a device for measuring wind speed and direction while being lightweight, low power, and low aerodynamic drag. This makes it suitable for airborne applications, particularly tethered systems such as kites, balloons, and drones. A sensor system detecting wind speed and direction plays a critical role in airborne tethered applications, such as kites, balloons, and drones, for precise control, trajectory optimization, and monitoring the environment. In addition, wind speed measurements serve as inputs in the wind energy sector for energy forecasting and to optimize the performance of wind turbines.

The devices, systems, and methods disclosed herein are for an airfoil-shaped, low-drag anemometer as part of a smart tether system. The smart tether system consists of several airfoil-shaped smart sleeves that not only reduce the overall drag on the system, but also perform sensing, actuation, and energy harvesting functions to control, optimize, and autonomize the airborne system. An airfoil profile provides up to 10 times lower aerodynamic drag than a circular cross-section with an equal frontal area. Each airfoil along the length of the tether rotates freely or is equipped with high torsional compliance to ensure its alignment with the direction of the wind to maximize drag reduction and increase the efficiency of the tethered airborne system.

Various implementations include a low-drag smart tether system for measuring fluid speed and direction. The system includes a sleeve, a pressure sensor, and a tether. The sleeve has a longitudinal axis and an airfoil shaped cross-section as viewed in a plane perpendicular to the longitudinal axis. The sleeve has a leading edge. The sleeve defines a tether opening extending parallel to the longitudinal axis. The pressure sensor is disposed along a surface of the sleeve. The pressure sensor is configured to measure the pressure exerted on the pressure sensor by air moving over the surface of the sleeve. The tether extends through the tether opening defined by the sleeve. The tether has a tether longitudinal axis. The tether opening is positioned such that fluid flowing around the sleeve causes the sleeve to rotate about the tether longitudinal axis.

One of the desired functionalities of the tethered airfoil is to simultaneously monitor the wind conditions, namely wind speed and direction, at a given altitude. Once the airfoil aligns with the direction of airflow, the orientation is measured using a non-contact sensor such as a 3D digital magnetometer compass embedded in the airfoil. This type of commercially available sensor measures the change in the earth's magnetic field intensity and measures absolute orientation of the airfoil relative to the earth's magnetic north. It consumes relatively low power (less than 0.1 mW) and has a low operating voltage, making it suitable for powering via energy harvesters.

Once the airfoil has aligned itself in the direction of the wind, the surface pressure at any given point along the length of the airfoil at a constant angle-of-attack is directly proportional to the square of the wind velocity. Due to the high resolution, conformability, and customization required for wind speed measurements, capacitive sensing technology is chosen over piezoelectric and piezoresistive techniques owing to its immunity to temperature changes, design flexibility, ease of fabrication, low cost, and low power consumption. The change in capacitance measured by the conformable capacitive pressure senor is directly related to the wind speed using analytical models or calibration charts generated using reference anemometers. Piezoelectric PVDF are used as the dielectric material for the deflecting diaphragm capacitor. Integration of PVDF also provides the potential for harvesting electrical energy from wind-induced vibrations to improve system autonomy.

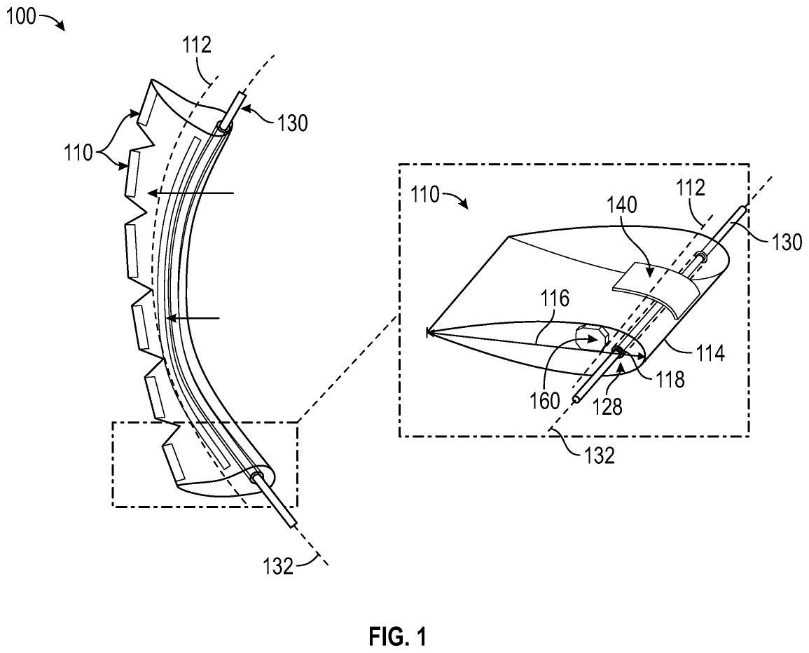

FIG. 1 shows a low-drag smart tether system 100 for measuring fluid speed and direction, according to aspects of various implementations. The system 100 includes sleeves 110, a tether 130, pressure sensors 140, and directional sensors 160.

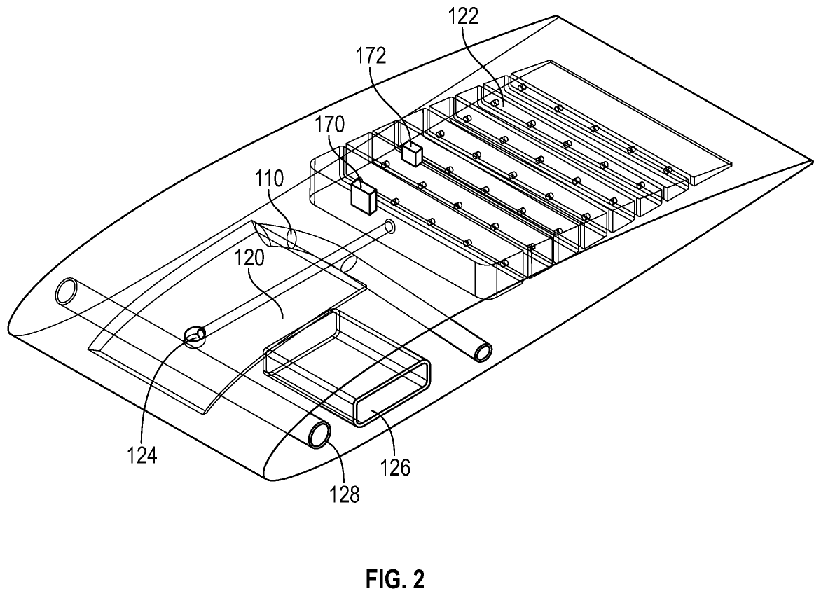

Each sleeve 110 has a longitudinal axis 112, a leading edge 114, a chord length 116, and a center of pressure 118. The sleeve 110 is an airfoil shaped cross-section as viewed in a plane perpendicular to the longitudinal axis 112. The airfoil shaped cross-section shown in FIGS. 1 and 2 is an asymmetric NACA 2412 airfoil shaped cross-section, but in other implementations, the cross-sectional shape of the sleeve can be any other airfoil shape, such as a symmetric airfoil (e.g., NACA 0015).

The sleeve 110 includes a honeycomb shaped interior covered by a smooth outer skin. The honeycomb shaped interior reduces the weight of the sleeve 110. The sleeve 110 is made of polystyrene, but in other implementations, the sleeve can be made out of any suitable material.

As shown in FIG. 2, the sleeve 110 defines a pressure sensor housing cavity 120, a reference pressure cavity 122, a reference pressure channel 124 fluidly connecting the pressure sensor housing cavity 120 and the reference pressure cavity 122, and a directional sensor housing 126.

The sleeves 110 further define a tether opening 128 extending parallel to the longitudinal axis 112. The tether 130 extends through the tether opening 128 defined by each of the sleeves 110 such that each of the sleeves 110 is rotatable about the tether 130 independently of the other sleeves 110. However, in other implementations, two or more of the sleeves may rotate together such that the sleeves are stationary relative to each other. In some implementations, the sleeves are statically coupled to the tether and can be designed with a high torsional compliance along the tether.

The tether opening 128 is positioned at a center of pressure 118 of the sleeve 110 such that fluid flowing around the sleeve 110 causes the sleeve 110 to rotate about the tether longitudinal axis 132. It has been shown that when the tether 130 is located at the center of pressure 118, which is approximately ¼ of the chord length 116, the moment created by air flowing over the airfoil is independent of the airspeed. In other words, the airfoil acts like a wind vane to orient itself to a unique and stable angle-of-attack, which is the angle between the chord 116 of the airfoil and the direction of the airflow. Therefore, the wind direction can be measured based on the angular position of the airfoil. Furthermore, once the airfoil is aligned with the wind direction, the pressure at any point on the surface of the airfoil is proportional to the wind velocity squared. Thus, wind speed can be determined by measuring the pressure acting on the surface of the airfoil. Although the tether opening in FIGS. 1 and 2 is located at approximately ¼ of the chord length 116, in other implementations, the tether opening is positioned between ⅛ and ⅜ of the chord length from the leading edge.

Although the system 100 shown in FIG. 1 includes six sleeves 110, in other implementations, the system includes any number of one or more sleeves. The tether 130 shown in FIG. 1 is made of Dyneema®, but in other implementations, the tether is made of any other suitable material.

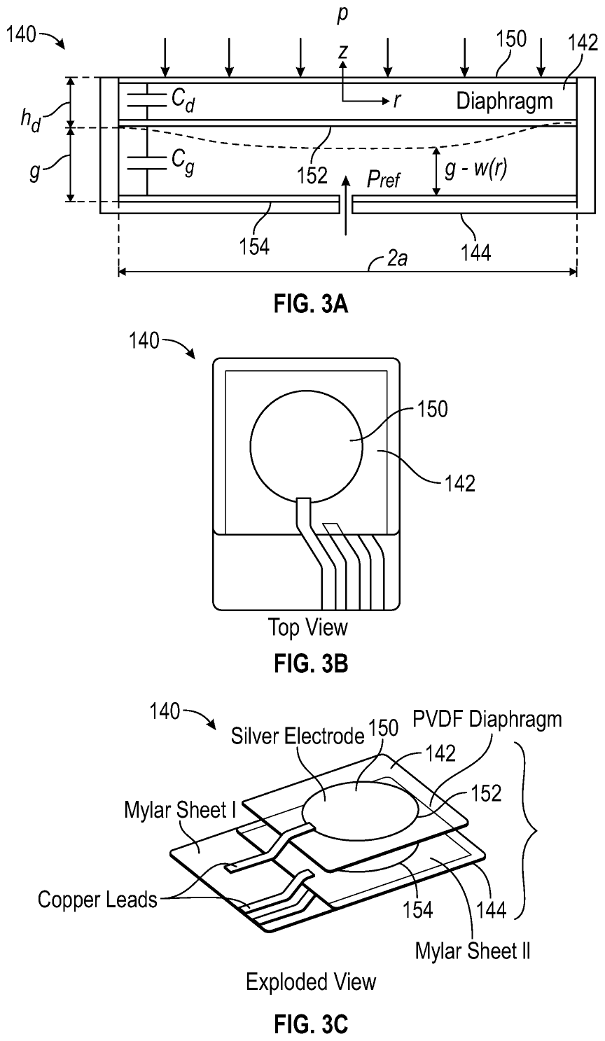

The pressure sensor 140 shown in FIG. 3 is a capacitive pressure sensor, specifically a dual-layer circular capacitive sensor. The pressure sensor 140 includes a dielectric skin 142, or diaphragm, with a first electrode 150 on one side of the skin 142 and a second electrode 152 on the opposite side of the skin 142. The pressure sensor 140 also includes an electrode 154 on the base 144 spaced apart from the skin 142. The pressure sensor 140 is disposed within the pressure sensor housing cavity 120 along a surface of the sleeve 110 at a location closer to the leading edge 114 of the sleeve 110 than to a tailing edge of the sleeve 110. The pressure sensor 140 includes a pressure sensitive skin 142 that is flush with the surface of the sleeve 110. The pressure sensor 140 is configured to measure the pressure exerted on the pressure sensor 140 by air moving over the surface of the sleeve 110.

The skin 142, or diaphragm, of the pressure sensor 140 covers the opening of the pressure sensor housing cavity 120. As the diaphragm 142 is deflected towards the electrode 154 at the base 144 of the pressure sensor 140, the air gap between the second electrode 152 of the diaphragm 142 and the electrode 154 on the base 144 of the pressure sensor 140 is reduced. The reduced air gap between the electrodes 152, 154 results in an increased capacitance across the electrodes 152, 154. Sensing range is limited by the pressure at which the diaphragm electrode 152 contacts the base electrode 154 but increasing the initial air gap thickness reduces the average pressure sensitivity. Therefore, there is a design tradeoff based on the inverse relationship between average pressure sensitivity and saturating sensing range. A key advantage of this configuration is that it can distinguish between positive and negative pressures.

Also, when wind exerts a pressure on the skin 142 of the pressure sensor 140, the diaphragm 142 stretches in-plane as it deforms, which reduces the thickness due to the Poisson's effect. When the thickness of the diaphragm 142 reduces, the first electrode 150 and second electrode 152 on either side of the diaphragm 142 become closer and, consequently, increases the capacitance. In contrast to the air gap capacitor, the sensing range of this configuration is limited only by the yield strength of the diaphragm 142 material, but it cannot distinguish between positive and negative pressures. The diaphragm capacitance is nearly linear with respect to applied pressure.

By using both sensor configurations together, the pressure sensor 140 can include the advantages of both configurations while accounting for each configuration's deficiencies.

The pressure sensor 140 can be a diaphragm pressure sensor, a strain-based pressure sensor, a piezo-electric sensor skin, and/or any other type of pressure sensor. In some implementations, it is possible to improve the performance (e.g., bandwidth or sensitivity) by using both piezoelectric and capacitance measurements in conjunction. For example, the PVDF diaphragm's 142 piezoelectric output could be measured at the same time as the air gap capacitance between electrodes on the diaphragm 142 and base 144 of the cavity below it. The pressure sensor housing cavity 120 covered by the skin or diaphragm 142 can be sealed or exposed to ambient conditions. The diaphragm 142 shown in FIG. 3 is made of polyvinylidene difluoride (PVDF) to increase sensitivity, but in other implementations, the diaphragm can be made of any suitable material (e.g., P (VDF-TrFE-CTFE)).

The directional sensor 160 is disposed within the directional sensor housing 126 defined by the sleeve 110. The directional sensor 160 is used for measuring the cardinal orientation of the sleeve 110 as the sleeve 110 is moved by the wind. The directional sensor 160 shown in FIGS. 1 and 2 is a magnetometer compass, but in other implementations, the directional sensor can be any other sensor for detecting a change in direction of the sleeve, such as an angular encoder for measuring the relative angle between the sleeve and the tether.

The system 110 can also include a controller 170 in communication with the pressure sensor 140 and the magnetometer 160. The controller 170 can include a wireless transmission device 172 for transmitting the sensor data to a remote location. The controller 170 and/or the wireless transmitting device 172 can be disposed within one or more of the sleeves 110 or one or both of the controller 170 and the wireless transmitting device 172 can be located along the tether 130 or remotely.

In some implementations, the piezoelectric pressure sensor can be used as an energy harvester to be used by the system, making the system more efficient or even self-sustaining. In some implementations, the energy harvesters are a separate device from the sensors. The goal is to integrate wind energy harvesters in the airfoil to improve system autonomy by harvesting electrical energy from flow-induced pressure variations and vibrations. In some implementations, the energy harvester can be a photovoltaic, thermoelectric, or any other type of energy harvester.

A number of example implementations are provided herein. However, it is understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

Disclosed are materials, systems, devices, methods, compositions, and components that can be used for, can be used in conjunction with, can be used in preparation for, or are products of the disclosed methods, systems, and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device are disclosed herein, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

What is claimed is:

1. A low-drag smart tether system for measuring fluid speed and direction, the system comprising:
a sleeve having a longitudinal axis and an airfoil shaped cross-section as viewed in a plane perpendicular to the longitudinal axis, the sleeve having a leading edge, wherein the sleeve defines a tether opening extending parallel to the longitudinal axis;
a pressure sensor disposed along a surface of the sleeve, wherein the pressure sensor is configured to measure the pressure exerted on the pressure sensor by air moving over the surface of the sleeve; and
a tether extending through the tether opening defined by the sleeve, the tether having a tether longitudinal axis,
wherein the tether opening is positioned such that fluid flowing around the sleeve causes the sleeve to rotate about the tether longitudinal axis.

2. The system of claim 1, wherein the pressure sensor comprises a strain-based pressure sensor.

3. The system of claim 1, wherein the pressure sensor comprises a capacitive pressure sensor.

4. The system of claim 1, wherein the pressure sensor comprises a piezo-electric sensor skin.

5. The system of claim 1, wherein the pressure sensor comprises a diaphragm pressure sensor.

6. The system of claim 1, wherein the pressure sensor comprises polyvinylidene difluoride (PVDF).

7. The system of claim 1, wherein the pressure sensor includes a pressure sensitive skin, wherein the pressure sensitive skin is flush with the surface of the sleeve.

8. The system of claim 1, wherein the pressure sensor is disposed closer to the leading edge of the sleeve than to a tailing edge of the sleeve.

9. The system of claim 1, further comprising a directional sensor for measuring the cardinal orientation of the sleeve, wherein the directional sensor is coupled to the sleeve.

10. The system of claim 9, wherein the directional sensor comprises a magnetometer compass.

11. The system of claim 9, wherein the directional sensor comprises an angular encoder.

12. The system of claim 1, wherein the tether comprises Dyneema®.

13. The system of claim 1, wherein the sleeve comprises polystyrene.

14. The system of claim 1, wherein the sleeve comprises a honeycomb shaped material.

15. The system of claim 1, wherein the sleeve is rotatable about the tether.

16. The system of claim 1, wherein the system includes two or more sleeves and two or more pressure sensors, wherein each of the two or more pressure sensors is disposed along the surface of a different one of the two or more sleeves.

17. The system of claim 16, wherein each of the two or more sleeves rotates independently of the other sleeves.

18. The system of claim 1, wherein the tether opening is positioned at a center of pressure of the sleeve.

19. The system of claim 1, wherein the sleeve has a chord length, and the tether opening is positioned between ⅛ and ⅜ of the chord length from the leading edge.

20. The system of claim 1, further comprising a controller in communication with the pressure sensor and the magnetometer.

21. The system of claim 20, wherein the controller includes a wireless transmission device.

22. The system of claim 1, wherein the airfoil shaped cross-section comprises a NACA 2412 airfoil shaped cross-section.

23. The system of claim 1, comprising an energy harvester.
